(19) United States
(12) Patent Application Publication
(10) Pub. No.: US 2022/0092514 A1
(43) Pub. Date: Mar. 24, 2022

(54) SKILL GAP ANALYSIS FOR TALENT MANAGEMENT

(71) Applicant: International Business Machines Corporation, Armonk, NY (US)

(72) Inventors: Madhusmita Guru, Hyderabad (IN); Parag Sanjay Mhatre, Pen (IN); Renjith Koorumullamkattil Mathew, Bengaluru (IN); Prasanna Chandrasekharan Nair, Bengaluru (IN); Karanam Rakesh, Bangalore (IN)

(21) Appl. No.: 17/031,268

(22) Filed: Sep. 24, 2020

(51) Int. Cl. G06Q 10/06; G06Q 10/10; G06N 20/00

(52) U.S. Cl. CPC G06Q 10/063112; G06N 20/00; G06Q 10/1053; G06Q 10/06398

(57) ABSTRACT

An approach for determining most a qualified employee for a job based on analyzing gap in between skill of the employee and the job description requirement is disclosed. The approach utilizes machine learning to extract key skills like functional skills of an employee profile from an organization and job descriptions with a hierarchy of profiles. The approach builds a multi-dimension vector representation for each employee key skills and job descriptions. The approach calculates the vector distance between the key skills in profile vector and job description vector and maintaining the scores for each node. Finally, the approach generates the skill gap summary for the employee by matching the job description with employee profiles.

### BACKGROUND

The present invention relates generally to software, and more particularly to identify a skill gap analysis between a job role and a and a user of an organization.

Skills management is field of recruiting, developing understanding and deploying workers and their skills. A robust skills-management approach (i.e., recruiting) can identify, a) the skills that job roles require, b) the skills of individual worker, and c) any gap between associated with the job role and individual worker.

The skills (e.g., primary, secondary, etc.) involved are typically either defined by the employer or a third-party institution. The primary skills are usually defined in terms of a skills framework, also known as a competency framework or skills matrix. The skill matrix can comprise of a list of skills, and a grading system. In some cases, employer can also use crowdsource data to define and calculate the grading system.

### SUMMARY

Aspects of the present invention disclose a computer-implemented method, a computer system and computer program product for matching an individual to a job role requirement. The computer implemented method may be implemented by one or more computer processors and may include: receiving a person data and job description data; generating a multi-dimension person vector representing one or more skills of a person; generating a multi-dimension job description vector representing one or more role requirements of a job description; analyzing one or more skill differences between the multi-dimension person vector and the multi-dimension job description vector; and generating a skill gap summary based on the analysis.

According to another embodiment of the present invention, there is provided a computer system. The computer system comprises a processing unit; and a memory coupled to the processing unit and storing instructions thereon. The instructions, when executed by the processing unit, perform acts of the method according to the embodiment of the present invention.

According to a yet further embodiment of the present invention, there is provided a computer program product being tangibly stored on a non-transient machine-readable medium and comprising machine-executable instructions. The instructions, when executed on a device, cause the device to perform acts of the method according to the embodiment of the present invention.

### BRIEF DESCRIPTION OF THE DRAWINGS

Preferred embodiments of the present invention will now be described, by way of example only, with reference to the following drawings, in which:

FIG. 1 is a functional block diagram illustrating a high level overview of the skill gap analysis environment and the equivalent graphics representation in accordance with an embodiment of the present invention;

FIG. 2 is a functional block diagram illustrating the subcomponents of skill component 111, in accordance with an embodiment of the present invention;

FIG. 3A is a diagram illustrating the high-level process of the skill gap analysis, in accordance with an embodiment of the present invention;

FIG. 3B is a diagram illustrating the tree pruning method, in accordance with an embodiment of the present invention;

FIG. 4 is a high-level flowchart illustrating the operation of skill component 111, designated as 400, in accordance with an embodiment of the present invention; and

FIG. 5 depicts a block diagram, designated as 500, of components of a server computer capable of executing the skill component 111 within the skill gap analysis environment, of FIG. 2, in accordance with an embodiment of the present invention.

### DETAILED DESCRIPTION

Embodiments of the present invention provides an automated approach for analyzing of any skill gaps between an employee and the job profile/description requirement. Performing a skill gap analysis can benefit employees and the organization since it addresses both the profession and the business needs. For example, a benefit from employee perspective, instead of just doing a course assigned to the employee by his/her manager, it helps if a proper assessment is done and personalized learning is provided based on the skill gaps. In another example, a benefit from employer perspective (i.e., the manager), instead of recommending courses based on market demands, the skill gap analysis will help to understand the employee skill proficiency level and from from a HR (human resource) perspective, the employee assessment helps in performance review, re-alignment to new roles and increase employee satisfaction and performance review/tracking.

The approach, leverages machine learning, can be summarized by the following: i) receiving an employee profile (including CV, evaluation reports and social profiles) from an organization and job descriptions with a pre-mentioned hierarchy of profiles, ii) extract key skills like function skills (Java, Python, etc.), soft skills (e.g., project Management, consulting, etc.) using trained entity recognition model from employee profiles and the job description, iii) build a multi-dimension vector representation for each employee key skills and job description's, iv) calculate vector distance between the key skills in profile vector and job description vector (based on optimized tree pruning approach based job roles) and maintaining the scores for each node; and v) generate the skill gap summary for the employee by matching the job description with employee profiles.

Other embodiments of the present invention may recognize one or more of the following facts, potential problems, potential scenarios, and/or potential areas for improvement with respect to the current state of the art: i) an automated approach to extract skills versus a manual approach, ii) a 360 degree view of the user profile instead of just a profile data, iii) an automated approach to identify individuals who needs to up-skill and provide a gap analysis report, iv) skill extraction is from multiple sources and validation, v) skills based profile creation is based on information available (i.e., can consider employee's public profile data, employee resume, employee assessment availability with the organization, peer review if available), vi) leveraging profile multi-dimension vectors with job description vector distance, vii) able to optimize for N employee profiles and D job description with tree pruning approach ,viii) gap analysis by leveraging NLP (natural language processing) and ix) uses semantic vector representation trained on a huge corpus which automatically learns and matches the skills which could be a latent information in the user profile.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

It should be understood that the Figures are merely schematic and are not drawn to scale. It should also be understood that the same reference numerals are used throughout the Figures to indicate the same or similar parts.

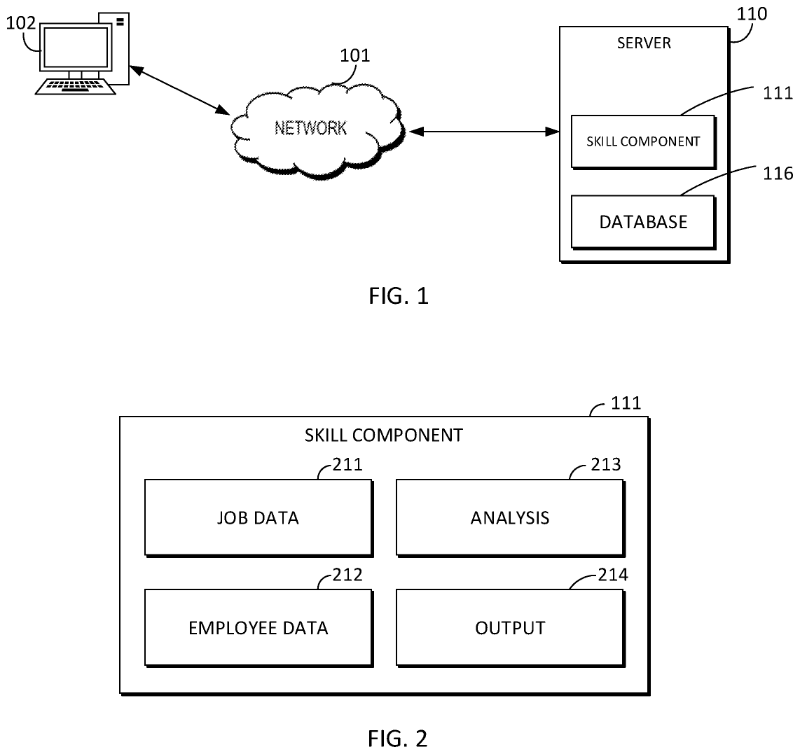

FIG. 1 is a functional block diagram illustrating a skill gap analysis environment in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Skill gap analysis environment includes network 101, client computing device 102 and server 110.

Network 101 can be, for example, a telecommunications network, a local area network (LAN), a wide area network (WAN), such as the Internet, or a combination of the three, and can include wired, wireless, or fiber optic connections. Network 101 can include one or more wired and/or wireless networks that are capable of receiving and transmitting data, voice, and/or video signals, including multimedia signals that include voice, data, and video information. In general, network 101 can be any combination of connections and protocols that can support communications between server 110, client computing device 102 and other computing devices (not shown) within skill gap analysis environment. It is noted that other computing devices can include, but is not limited to, client computing device 102 and any electromechanical devices capable of carrying out a series of computing instructions.

Server 110 and client computing device 102 can be a standalone computing device, a management server, a web server, a mobile computing device, or any other electronic device or computing system capable of receiving, sending, and processing data. In other embodiments, server 110 and client computing device 102 can represent a server computing system utilizing multiple computers as a server system, such as in a cloud computing environment. In another embodiment, server 110 and client computing device 102 can be a laptop computer, a tablet computer, a netbook computer, a personal computer (PC), a desktop computer, a personal digital assistant (PDA), a smart phone, or any other programmable electronic device capable of communicating other computing devices (not shown) within skill gap analysis environment 100 via network 101. In another embodiment, server 110 and client computing device 102 represents a computing system utilizing clustered computers and components (e.g., database server computers, application server computers, etc.) that act as a single pool of seamless resources when accessed within skill gap analysis environment.

Client computing device 102 can be a computing device with the capability of managing employee data (e.g., profile, skills, etc.) and job data (e.g., profile, requirements, skills required, etc.). Client computing device 102 can include HR (human resources) related software, such as, recruiting tools, job database and training.

Embodiment of the present invention can reside on server 110. Server 110 includes skill component 111 and database 116.

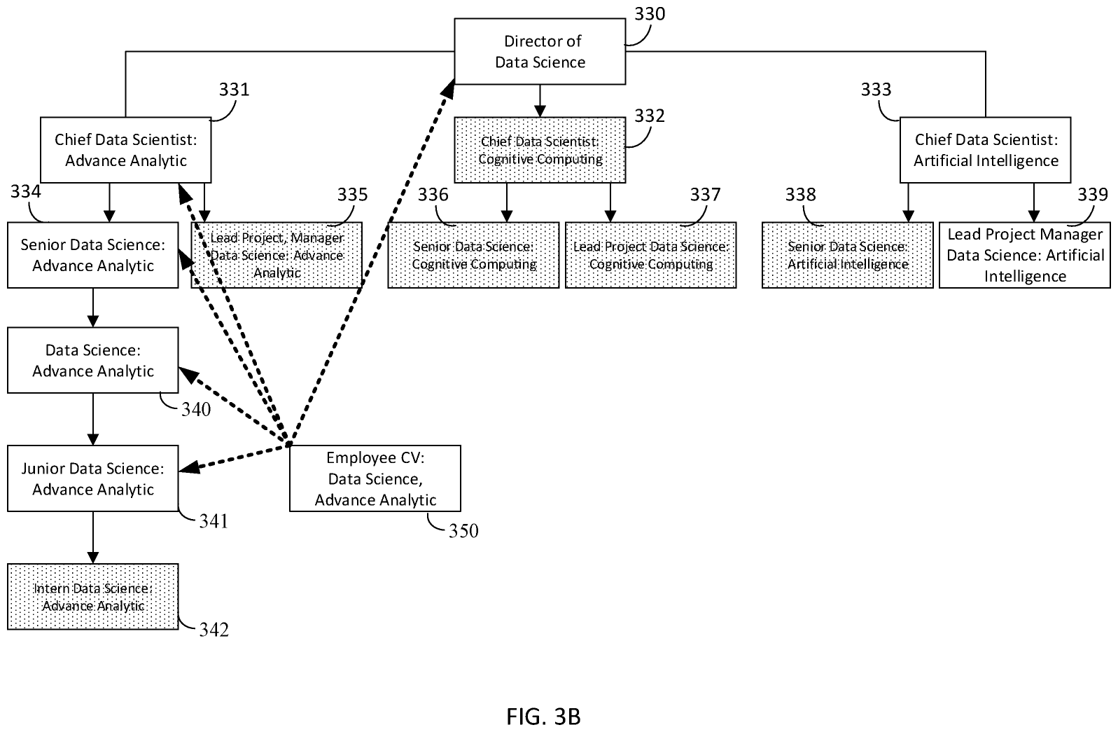

Skill component 111 provides the capability of, i) extracting skill from an employee profile and job description, ii) representing the skills and profile using multi-dimension vectors and iii) perform gap analysis between the employee profile and job description. See FIG. 3A for a high-level overview.

Database 116 is a repository for data used by skill component 111. Database 116 can be implemented with any type of storage device capable of storing data and configuration files that can be accessed and utilized by server 110, such as a database server, a hard disk drive, or a flash memory. Database 116 uses one or more of a plurality of techniques known in the art to store a plurality of information. In the depicted embodiment, database 116 resides on server 110. In another embodiment, database 116 may reside elsewhere within skill gap analysis environment, provided that skill component 111 has access to database 116. Database 116 may store information associated with, but is not limited to, all skills related to all jobs, training data for skills, profile data related to the employee including skills (i.e., person data) and job description (i.e., job description data) including requirements. Person data can include evaluation reports (e.g., performance assessment, quarterly/yearly review, etc.), social media profiles, manager feedback, peer review feedback, client feedback, deliverables met, and performance feedback, etc. Job description data includes multiple hierarchy of a profile, skills required for the role (e.g., soft skills, functional skills, business, etc.) and proficiency level of each skill.

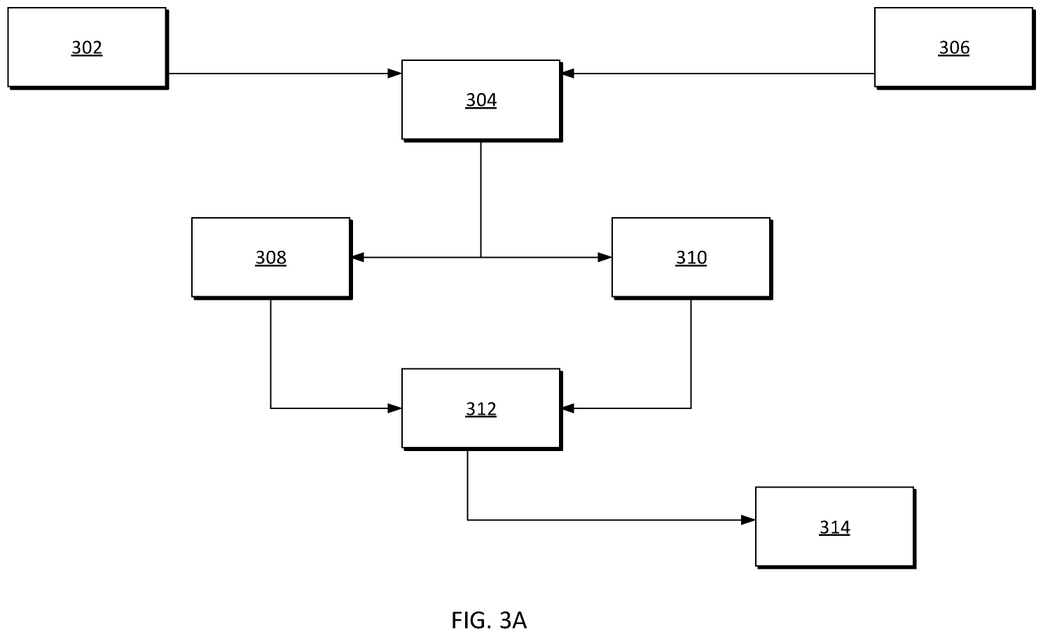

FIG. 2 is a functional block diagram illustrating skill component 111 in accordance with an embodiment of the present invention. In the depicted embodiment, skill component 111 includes job data component 211, employee data component 212, analysis component 213 and output component 214. FIG. 3A will be used to illustrate a high-level overview of skill component 111.

As is further described herein below, job data component 211 of the present invention provides the capability of extracting data related to the job profile and representing the data as multi-dimensional vectors. Data input 306 (of FIG. 3A) represents incoming data to be fed into extraction block 304. 306 represents D (variable representing unknown number of job description) job description required by the employer. Job data can include multiple hierarchy of a profile. For example, for a chief data scientist, there can exists several branches (i.e., hierarchy) from the main root (of chief data scientist): i) senior data scientist, ii) data scientists and iii) junior data scientist. Each of the tree node can have job description attached. Analysis component 213 (i.e., block 304) can begin to extract relevant skills using machine learning techniques which can include custom name entity recognition and abstract concept. After extraction, job data component 211 can represent (i.e. convert semantic data into multi-dimension vectors) job data as job description vectors. It is noted that each hierarchical job profiles can be presented as multi-dimensional vectors.

As is further described herein below, employee data component 212 of the present invention provides the capability of extracting data related to the employee profile and representing the data as multi-dimensional vectors. Data input 302 represents incoming data to be fed into the system. 302 represents N (variable representing unknown number of employee's resume) of resume of employees. Data for 302 can also include evaluation reports (e.g., performance assessment, quarterly/yearly review, etc.), social media profiles, manager feedback, peer review feedback, client feedback, deliverables met, and performance feedback, etc. Thus, the data (from all sources) can provide an accurate representation of employee skills and its proficiency level based on the experience captured.

Employee data component 212 and job data component 211 (i.e., block 304) can begin to extract relevant skills (e.g., functional, soft, behaviors, etc.) using machine learning techniques which can include custom name entity recognition and abstract concept. A machine learning technique for skill extraction can use Word2Vec word embedding or any word standard word embedding can be used. A custom classification model to build the skills based on the selection can be used and/or provided by an SME (subject matter expert). Furthermore, the model can be a custom definition based on organization need to industry standard. For example for “Understanding Customer Needs” from a sample resume) the definition used was “Knowledge of customer needs analysis principles, processes and skills; ability to recognize and be sensitive to the different perspectives and priorities of different customers.” The definition from the client was improved upon the AI by using a domain/skill dictionary (e.g., positive words like loyalty, pleasant associated with understanding customer needs reinforces that the person is skilled enough in the area, etc.). Additionally, deep learning (LSTM) models can be used to surface out additional characters to reinforce that the results are aligned. And addition business rules, such as, presence of certain recognized words can help validate skills.

In a few cases, (especially for technology skills), it possible that the AI skill extraction may only be able to recognize the adjacent skills for matching. For example, if a person has passed a PMP certification, but the experience does not have any mention have any project management skills then also the AI extraction model computes the person's skill for project management at “Experienced” level. Similarly, for other skills and/or certification, the similar approach can be used. In another example, if the word, “Python” is in the job description and the employee profile has the phrase, “Programming language” then analysis component 213 can recognize that the employee does have a programming language experience instead of using exact word match with current existing talent recruiting software.

After extraction, employee data component 212 represents (i.e. convert semantic data into multi-dimension vectors) employee data as employee profile vectors (i.e., block 308). Similarly, job data component 211 represents job description data as job description vectors(i.e., block 310). It is noted that each employee skill and/or job description can be presented as multi-dimensional vectors. It is further noted that extracting skills and representing the profile using multi-dimension vectors covering all technical, functional and behavioral skills. Technical and functional skills can be figured out from common source of data but behavioral skill is very abstract and can only be accessed from feedback/employee behavior captured in the form of assessments.

There are data that cannot be inferred from a resume and social data. For example, if a resume contains the job role of a “director of the finance department”, what does it really mean? At the office director level did the employee perform well? Did the employee have a, b, c skills at certain level to perform as a director? Did the employee exhibit such behavior at the required level? For example, the employee has people management responsibility. What is the level of competency exhibited during those managerial roles over those employees?

As is further described herein below, analysis component 213 of the present invention provides the capability of, 1) perform gap analysis by calculating vector distance and 2) process the gap analysis using NLP/machine learning techniques (i.e., generate skill gap summary report/data). The first step of analysis component (i.e., perform gap analysis) can be defined by 312 of FIG. 3A. Analysis component 213 (block 312) can calculate the vector distance between the skills from employee profile vector and job description vector. Any technique (e.g., cosine distance/similarity, Euclidean distance, etc.) can be used to compare/calculate vector distances/similarities. However, the comparison calculation can get very large if the organization has many hundreds and thousands of employees. Thus, solving for

$$n * Cd = \frac{n !}{rd ! * ( n - d ) !}$$

can require large computational power. The formula represented can be read as the combination formula (n combination d is equal to n factorial divided by (r multiplied with d factorial and (n-d) factorial). Thus, in an organization, there will be “N” employees and “D” job description. Each employee will have “n” skills and descriptions will have “d” skills. Computing skills gap analysis for each employee will be an (N*D) operation. For example, if an organization has 4 million employees and 1000 Job Roles then the number of computation will be 4 million*1000 Computations (that is thousand times of four million).

To optimize the comparison, a tree pruning approach (see FIG. 3B) is used to optimize the above computation. In every organization, the job roles can be represented in a tree structure, as each job role will have different levels or ranks and associated departments or business units. For skill gap analysis, the tree pruning approach would help compute the skill gap between current job roles and its parent job roles as well as current job role and adjacent job roles. For implementation, analysis component 213 can use the smallest tree pruning approach or minimum error pruning approach depending on the data set and information available. It is note that the approach does not consider any score for tree pruning as it would depend on the data set.

FIG. 3B is a diagram illustrating the tree pruning method and will be used to illustrate a use case for employee_A. Employee_A 350 is a junior data scientist in the Advance Analytic branch of the Data Science department. The upper node will be the most senior post (i.e., director 330) and the lower one will be junior post (i.e., intern 347) in the tree. The tree-pruning approach will compare the profile (of employee_A 350) with the root level of each tree and across the horizontal level (e.g., chief data scientist of advance analytic 331, chief data scientist of cognitive computing 332, chief data scientist of artificial intelligence 333). Based on the employee profile, the cognitive computing (e.g., senior data science of cognitive 336 and lead project manager of cognitive 337) and artificial branch (e.g., senior data science AI 338, Lead Project manager of AI 339) can be eliminated. Since employee_A 350 belongs to the advance analytic group, the entire branch (e.g., senior data science advance analytic 334, lead project manager advance analytic 335, data science advance analytic 340, junior data science advance analytic 341), excluding intern data science 342, is included in the computation. However, in the next iteration of pruning, the position of lead project manager advance analytic 335 is eliminated since it does not related to employee_A 350's job profile. Once the tree is finalized, other trees/branch can be pruned, which will optimize the computational limitation.

The second step of analysis component 213 (i.e., process the gap analysis using NLP) can be defined by 314 of FIG. 3A. Once the vector calculation has completed and the best matching job description and employee profiles are summarized by 314. Analysis component 213 (block 314) can utilized NLP engine (and/or a machine learning technique) to create a skill gap summary report with the best matching job description. The skill gap summary report can contain the following, i) skills of the employee that best matches the job description and ii) which employee does not have the skill present in the current job description.

It is noted that the gap computed is not a one-to-one match. The system calculates multiple skills at different levels and provides preference to skill types at various levels. However, for a skill gap, there is a difference between required skill and competency proficiency level with existing proficiency level. The computation score takes into consideration the ask by organization for each of the skill type. For example, for performing as a “Data science director” the individual needs Leadership skills at Higher level and Business skills at a higher level than the technical skills. The score is calculated as, Score =x* (sum of (functional skills weighted))+y*(sum of (behavioral skills weighted))+z*(sum of (technical skills weighted)). Another way to view the above score equation is using this alternative formula, “score=x*gaps in individual skills+y*Business skills+z*Leadership skills+n”, where n can denote other gaps in skills. For example, the type of skill (from the above equation) is dependent on the role type. For each skill mapped for the skill type (i.e., Individual skill) at the proficiency level, system allocates a 1. If the skill mapped is at a lower level then it is assigned a 0. If the skill mapped is at a higher level, then it is assigned a 2. X and Y (referring to the score equation) are coefficients which decides the weightage that need to be provided for each skill type. For example, for some roles individual skills need to be given a higher weightage. To illustrate further, for a data scientist junior the individual skills (x) value can be given 30% weightage, Business skills (y value) 10%, Leadership skills (z value) 10%, Technical skills (may be another coefficient) 50%. Whereas for a Data scientist director the weightage can be completely different. Something like individual skills (x) value can be given 30% weightage, Business skills (y value) 30%, Leadership skills (z value) 30%, Technical skills (may be another coefficient) 10%. This gap score would help determine the actual gaps.

As is further described herein below, output component 214 of the present invention provides the capability of, communicating the skill gap summary report to a user and/or a HRIS (human resource information system). For example, output component 214 can email the skill gap report to a recruiting analyst within the organization. Alternatively, the gap analysis report can be used by HR to identify employees that needs training or identify a career path progression for an employee.

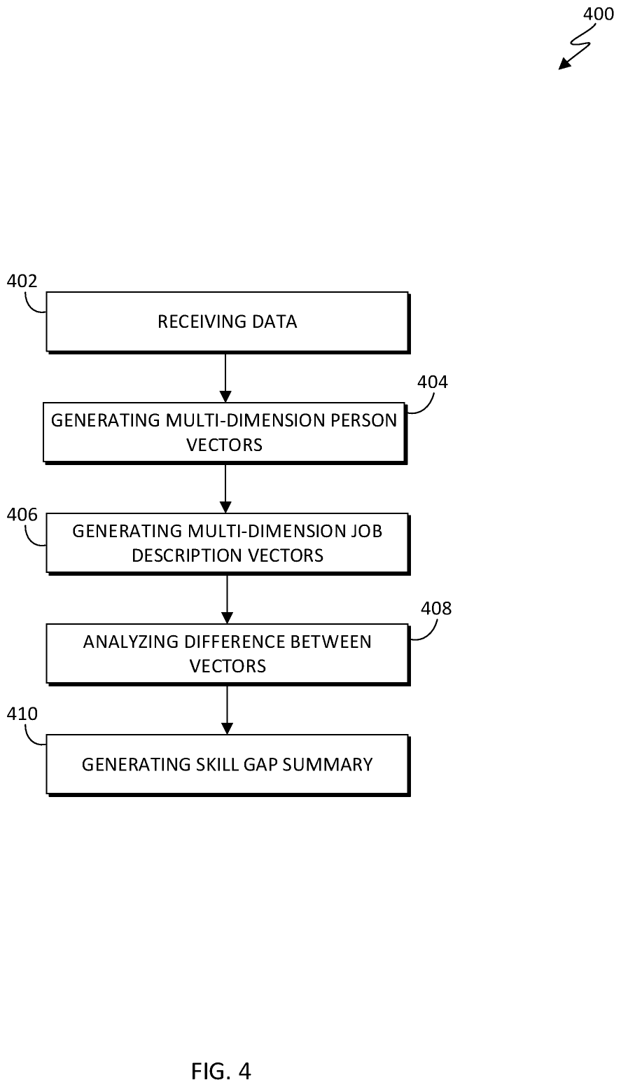

FIG. 4 is a high-level flowchart illustrating the operation of skill component 111, designated as 400, in accordance with an embodiment of the present invention.

Skill component 111 receives data (step 402). In an embodiment, skill component 111, receives resume of an employee and job role from an organization. For example, ACME Inc. employs employee_A 350, a junior data scientist. HR (Human Resources) department would like to identify skill gaps of employees within the organization to determine what training program are needed and/or career goal path. Thus, HR department of ACME Inc. gathers data from internal database that includes employee's resume, feedback and job descriptions of all jobs within the company.

In another embodiment, a talent acquisition portion of HR department would like to search for suitable candidate based on the various resumes received for an open job role, junior data scientist of ACME Inc.

Skill component 111 generates a person vector (step 404). In an embodiment, skill component 111, through employee data component 212, generates a multi-dimensional vector that represents the job skills of the employee. For example, a multi-dimensional vector is created for employee_A 350 that is based on the skillset (e.g., data analytical skill, programming computing skill, etc.).

Skill component 111 generates job description vector (step 406). In an embodiment, skill component 111, through job data component 211, generates a multi-dimensional vector that represents the job description. For example, a multi-dimensional vector is created for next higher-up role than the current role of employee_A 350 (i.e., senior data science 334).

Skill component 111 analyzes the difference between the two vectors (step 408). In an embodiment, analysis component 213, through analysis component 213, analyzes the two vectors using cosine similarity technique.

Skill component 111 generates skill gap summary (step 410). In an embodiment, skill component 111, through analysis component 213, generates a gap summary report based on the analysis. For example, a gap summary report for Employee_A can be viewed as tabular format or as a summary. A skill gap summary of employee_A is listed below:

“The candidate exhibits sound knowledge of computer science fundamentals, object-oriented programming, excellent debugging, and in-depth analytical reasoning skills. He/she has a thorough command over any of the third-generation programming language—Python. He/she may have solid understanding of data structures and some of the most commonly used algorithms. He/she needs to improve on his/her design and coding practices and a desire to develop new bold ideas. He/she has demonstrated excellent verbal and written communication skills. He/she needs to improve on his/her ability to work independently and multi-task effectively.”

An example of a tabular format of the gap summary is listed below in Table 1.

TABLE 1

| | | | | Skill | Skill from |
|---|---|---|---|---|---|
| Skill Type | Required Skill | Proficiency | Importance | Match | user profile |
| Business | Information | Extensive | High | YES | Extensive |
| | Capture | Experience | | | Experience |
| Individual | Working | Expert | Medium | No | Basic |
| | Independently | | | | Understanding |
| Technical | Computer | Extensive | High | Yes | Extensive |
| | Science | Experience | | | Experience |
| Technical | Programming | Extensive | High | No | Medium |
| | | Experience | | | Understanding |
| Business | Communication: | Expert | High | Yes | Expert |
| | Written | | | | |

After generating the skill gap summary, skill component 111 can output the summary via email to the appropriate user in HR of the company.

In another embodiment, the gap summary can be associated with a potential candidate for an open job role within ACME Inc., where the important skillset of the job role is included as a column. See table 2 below:

TABLE 2

| Candidate | | | |
|---|---|---|---|
| Name | Skill set 1 | Skill set 2 | Skill set 3 |
| John | YES, | NO | YES, |
| Smith | Expert | | Intermediate |
| Judy | YES, | YES, | YES, |
| Garland | Intermediate | Intermediate | Expert |

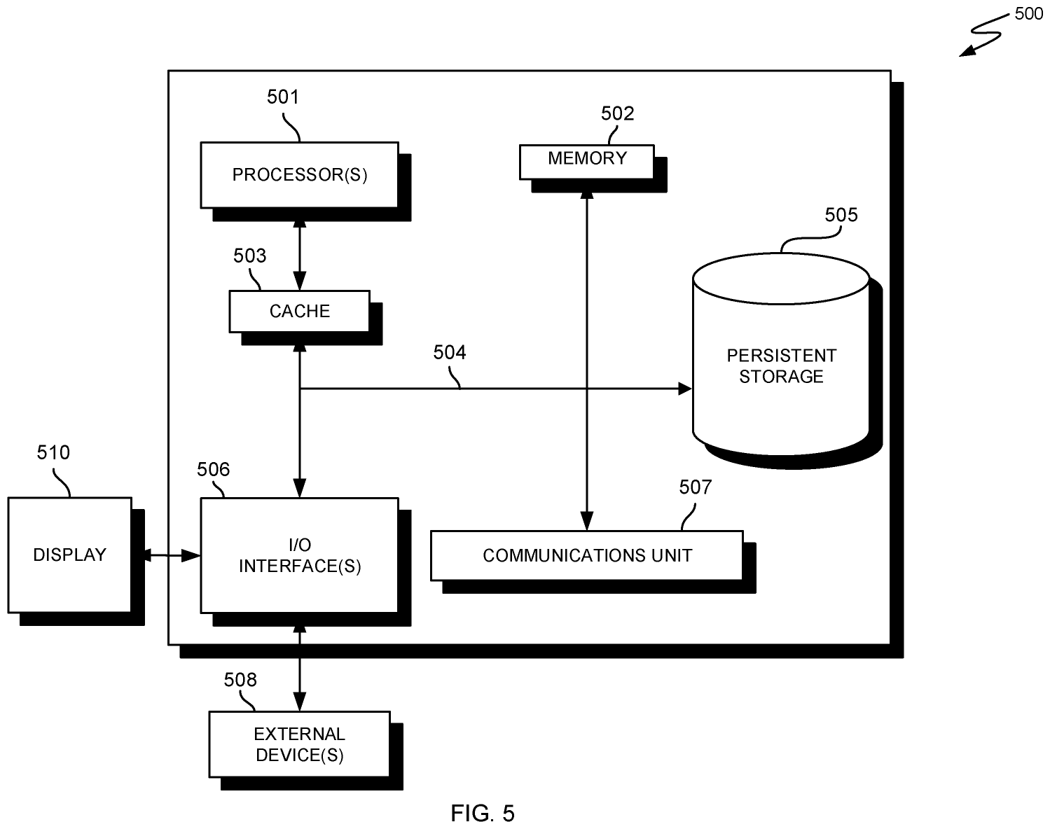

FIG. 5, designated as 500, depicts a block diagram of components of skill component 111 application, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

FIG. 5 includes processor(s) 501, cache 503, memory 502, persistent storage 505, communications unit 507, input/output (I/O) interface(s) 506, and communications fabric 504. Communications fabric 504 provides communications between cache 503, memory 502, persistent storage 505, communications unit 507, and input/output (I/O) interface(s) 506. Communications fabric 504 can be implemented with any architecture designed for passing data and/or control information between processors (such as microprocessors, communications and network processors, etc.), system memory, peripheral devices, and any other hardware components within a system. For example, communications fabric 504 can be implemented with one or more buses or a crossbar switch.

Memory 502 and persistent storage 505 are computer readable storage media. In this embodiment, memory 502 includes random access memory (RAM). In general, memory 502 can include any suitable volatile or non-volatile computer readable storage media. Cache 503 is a fast memory that enhances the performance of processor(s) 501 by holding recently accessed data, and data near recently accessed data, from memory 502.

Program instructions and data (e.g., software and data x 10) used to practice embodiments of the present invention may be stored in persistent storage 505 and in memory 502 for execution by one or more of the respective processor(s) 501 via cache 503. In an embodiment, persistent storage 505 includes a magnetic hard disk drive. Alternatively, or in addition to a magnetic hard disk drive, persistent storage 505 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 505 may also be removable. For example, a removable hard drive may be used for persistent storage 505. Other examples include optical and magnetic disks, thumb drives, and smart cards that are inserted into a drive for transfer onto another computer readable storage medium that is also part of persistent storage 505. Skill component 111 can be stored in persistent storage 505 for access and/or execution by one or more of the respective processor(s) 501 via cache 503.

Communications unit 507, in these examples, provides for communications with other data processing systems or devices. In these examples, communications unit 507 includes one or more network interface cards. Communications unit 507 may provide communications through the use of either or both physical and wireless communications links. Program instructions and data (e.g., Skill component 111) used to practice embodiments of the present invention may be downloaded to persistent storage 505 through communications unit 507.

I/O interface(s) 506 allows for input and output of data with other devices that may be connected to each computer system. For example, I/O interface(s) 506 may provide a connection to external device(s) 508, such as a keyboard, a keypad, a touch screen, and/or some other suitable input device. External device(s) 508 can also include portable computer readable storage media, such as, for example, thumb drives, portable optical or magnetic disks, and memory cards. Program instructions and data (e.g., Skill component 111) used to practice embodiments of the present invention can be stored on such portable computer readable storage media and can be loaded onto persistent storage 505 via 1/0 interface(s) 506. 1/0 interface(s) 506 also connect to display 510.

Display 510 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. I t will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for matching an individual to a job role requirement, the computer-implemented method comprising:
receiving a person data and job description data;
generating a multi-dimension person vector representing one or more skills of a person;
generating a multi-dimension job description vector representing one or more role requirements of a job description;
analyzing one or more skill differences between the multi-dimension person vector and the multi-dimension job description vector; and
generating a skill gap summary based on the analysis.

2. The computer-implemented method of claim 1, wherein the person data further comprises of, evaluation reports, social media profiles, manager feedback, peer review feedback, client feedback, deliverables met, and performance feedback.

3. The computer-implemented method of claim 1, wherein the job description data further comprises of, multiple hierarchy of a profile, skills required for the role and proficiency level of each skill.

4. The computer-implemented method of claim 1, wherein generating a multi-dimension person vector further comprises of converting the one or more skills into the multi-dimension person vector using Word2Vec technique via machine learning.

5. The computer-implemented method of claim 1, wherein generating a multi-dimension job description vector further comprises of converting the one or more skills into the multi-dimension job description vector using Word2Vec technique via machine learning.

6. The computer-implemented method of claim 1, wherein analyzing one or more skill differences is based on cosine similarity technique.

7. The computer-implemented method of claim 1, further comprising:
outputting the skill gap summary via email to a human resource analyst.

8. A computer program product for determining most a qualified employee for a job based on analyzing gap in between skill of the employee and the job description requirement, the computer program product comprising:
one or more computer readable storage media and program instructions stored on the one or more computer readable storage media, the program instructions comprising:
program instructions to receive a person data and job description data;
program instructions to generate a multi-dimension person vector representing one or more skills of a person;
program instructions to generate a multi-dimension job description vector representing one or more role requirements of a job description;
program instructions to analyze one or more skill differences between the multi-dimension person vector and the multi-dimension job description vector; and
program instructions to generate a skill gap summary based on the analysis.

9. The computer program product of claim 8, wherein the person data further comprises of, evaluation reports, social media profiles, manager feedback, peer review feedback, client feedback, deliverables met, and performance feedback.

10. The computer program product of claim 8, wherein the job description data further comprises of, multiple hierarchy of a profile, skills required for the role and proficiency level of each skill.

11. The computer program product of claim 8, wherein program instruction to generate a multi-dimension person vector further comprises of converting the one or more skills into the multi-dimension person vector using Word2Vec technique via machine learning.

12. The computer program product of claim 8, wherein program instruction to generate a multi-dimension job description vector further comprises of converting the one or more skills into the multi-dimension job description vector using Word2Vec technique via machine learning.

13. The computer program product of claim 8, wherein program instruction to analyze one or more skill differences is based on cosine similarity technique.

14. The computer program product of claim 8, further comprising:
program instruction to output the skill gap summary via email to a human resource analyst.

15. A computer system for determining most a qualified employee for a job based on analyzing gap in between skill of the employee and the job description requirement, the computer system comprising:
one or more computer processors;
one or more computer readable storage media;
program instructions stored on the one or more computer readable storage media for execution by at least one of the one or more computer processors, the program instructions comprising:
program instructions to receive a person data and job description data;
program instructions to generate a multi-dimension person vector representing one or more skills of a person;
program instructions to generate a multi-dimension job description vector representing one or more role requirements of a job description;
program instructions to analyze one or more skill differences between the multi-dimension person vector and the multi-dimension job description vector; and
program instructions to generate a skill gap summary based on the analysis.

16. The computer system of claim 15, wherein the person data further comprises of, evaluation reports, social media profiles, manager feedback, peer review feedback, client feedback, deliverables met, and performance feedback.

17. The computer system of claim 15, wherein the job description data further comprises of, multiple hierarchy of a profile, skills required for the role and proficiency level of each skill.

18. The computer system of claim 15, wherein program instruction to generate a multi-dimension person vector further comprises of converting the one or more skills into the multi-dimension person vector using Word2Vec technique via machine learning.

19. The computer system of claim 15, wherein program instruction to generate a multi-dimension job description vector further comprises of converting the one or more skills into the multi-dimension job description vector using Word2Vec technique via machine learning.

20. The computer system of claim 15, wherein program instruction to analyze one or more skill differences is based on cosine similarity technique.
